(19) United States
(12) Patent Application Publication
(10) Pub. No.: US 2011/0115914 A1
(43) Pub. Date: May 19, 2011

(54) Sequential Hardware Event Processor with Video Event Compression and Recall

(75) Inventors: Kenneth S. Bailey, San Jose, CA (US); Paul S. Mula, San Jose, CA (US)

(73) Assignee: CLEAR-VIEW-TECHNOLOGIES, INC., San Jose, CA (US)

(21) Appl. No.: 12/943,384

(22) Filed: Nov. 10, 2010

Related U.S. Application Data
(60) Provisional application No. 61/280,941, filed on Nov. 10, 2009.

(51) Int. Cl. H04N 7/18; G06Q 10/00

(52) U.S. Cl. 348/150; 705/28; 348/E07.085

(57) ABSTRACT

A real-time Event Processing System (EPS) for processing a sequence of events generated by one or more pieces of hardware. The Event Processor collects data generated by the several transducers or appliances as they communicate with the server platform to indicate user activity of the attached hardware. As a packet data is received from one of the appliances, the data is date and time stamped and stored in anticipation of the next data event to which it can be paired or compared with. Stored event data is compared to a template of normalized data results to see if the event data was normal or abnormal. If the event data as compared was normal, no action is taken beyond storing said data. If the stored data is determined to be outside the pre-determined or pre-assigned data range, then a video camera captures the user activity just proceeding, during, and subsequent to the event for a short duration (such as a 1 minute duration), such that the stored video can later be viewed and interrogated to determine what action(s) caused the unacceptable event.

This application claims priority from provisional application No. 61/280,941, filed Nov. 10, 2009, the entire contents of which are herewith incorporated by reference.

### BACKGROUND

The use of video cameras to monitor theft, robbery, and unusual activities has been employed by various establishments.

Many nightclubs and bars have video cameras positioned to capture events such as fights between customers, potential shootings or knifings, or accidents by patrons which might result in lawsuits against the owners, such as a slip or a fall by a drunk or careless patron.

### SUMMARY

The present application describes an event processor that determines at which event times it is likely that an employee actions should be monitored, and coordinates those events against other actions such as video clips.

### BRIEF DESCRIPTION OF THE DRAWINGS

in the drawings:

FIG. 1 depicts the event processor and the several hardware components that comprise the entire system along with server and software as might be found in the preferred embodiment.

FIG. 2 depicts several software filters for the various hardware components that might be found in the preferred embodiment.

FIG. 3 depicts the system flow chart diagram as might be comprised in the preferred embodiment.

FIG. 4 depicts the system flow chart diagram as might be comprised in the preferred embodiment.

FIG. 5 depicts the video parser flow chart as might be found in the preferred embodiment.

FIG. 6 depicts the nested subroutines that are comprised in the preferred embodiment software.

FIG. 7 depicts the client side of the event processor as might be found in a venue.

### DETAILED DESCRIPTION

A real-time Event Processing System is described for processing a sequence of events generated by one or more pieces of hardware. The Event Processor collects data generated by the several transducers or appliances as they communicate with the server platform to indicate user activity of the attached hardware. As packet data is received from one of the appliances, the data is date and time stamped and stored. The data is then associated with the timing so that it can be compared with other data to find events to which it can be paired or otherwise compared.

According to an embodiment, stored event data is compared to a template of normalized data results to determine if the event data was normal or abnormal. If the event data as compared was normal, that is, does not differ from what is expected, then no action is taken beyond storing said data. If the stored data is determined to be outside the pre-determined or pre-assigned data range, then a video camera captures the user activity that is proceeding, during, and subsequent to the event for a short duration (such as a 1 minute duration). This captured data is used, such that the stored video can later be viewed and interrogated to determine what action(s) caused the unacceptable event.

In one embodiment, the video is being constantly taken such as with a digital video recorder or the like, so that different segments of the video can be captured and retained as needed, and data from those segments can be associated with the events, as necessary.

An embodiment uses a combination of parameters to identify times when abnormal or unusual events that may occur during the course of business which the owner or management considers unacceptable or forbidden by the employees. These times of the abnormal events and hence the events themselves, are captured on video and stored as individual 1 to 2 minute video clips for future review and/or analysis by the management. The system therefore parses the video events to separate negative events (which require management's attention) from normal events which constitute acceptable behavior and require no management intervention.

In the case of nightclub employees, unusual activities had often gone unnoticed unless the club owner employed paid spotters at the bar to monitor employee's activities. In the context of the nightclub or bar, many employee over pours and under rings, are hard to spot even by trained eyes. This was especially the case in a busy bar, which is a fast paced, dimly lit establishment during peak traffic times.

The present system is very different than a simple video surveillance system, since one single event, referred to herein as the “negative event”, is singled out from hours of otherwise mundane activity, and video that has little or no significance to the issue of the event. At the end of the evening, assuming the nightclub is open from 9:00 pm till 2:00 am, there could be 5 hours of video per camera multiplied by a number of cameras to review. Without a frame of reference for the event, such as, the building caught on fire around 11:00 pm, or the patron fell down the stairs at around midnight, there is just too much captured video to review. Effectively, this is why most establishments would agree that, they rarely, if ever, review their captured video unless the Police, or their lawyer request video of a singular event, within a known or given timeframe.

Employee theft, which goes on at random throughout the evening, is probably done in such a manner that other employees or paid spotters cannot easily detect, is extremely hard to pinpoint, which is why (up until now) the employees normally do not get caught at employee theft.

According to an embodiment, each item dispensed or poured, such as a bottle of Dom Perignon or a shot of “Gentleman Jack” whiskey, is monitored by RFID tagging (for movement) and weighing (for content depletion), and the event is time and date stamped, then stored in a central database.

An employee logs in, e.g., to a touch screen server. This event is similarly time and date stamped and stored in the central database. When a “negative” event occurs, the event processor flags the event as a negative event, that needs to be investigated. The event is identified in this way, but many of these identifications might actually be false alarms. Accordingly, the event processor determines when it is likely that a negative event may have occurred, and the information which can determine whether or this is or is not actually a negative event is assembled.

Negative events can include, as described herein, an item is not rung up as it is dispensed or moved, or a software filter detecting a discrepancy in the amount rung up, as opposed to the amount that should have been rung up.

Once a specific (negative) event has been logged, the event processor flags the video images in the area of the building the event occurred and determines which camera would have recorded the images of interest (the employee theft). The video images for the time(s) of interest (i.e. the past 1-5 minutes) are then separated into a smaller file and tagged with the event information: the employee's name and the time and date the event occurred. Once the event is logged and stored, it is flagged as a negative event and sent to the designated person's (owner's or manager's) email or PDA. Only the portion of the surveillance video appropriate to the event is sent, which can be, for example, 1-5 minutes of video from 1-3 video cameras. This then allows the manager or owner to take immediate disciplinary action to correct the problem or dismiss the employee who is responsible.

In the case where the owner or manager is not at the club or site, or is even out of town or on vacation, then he or she can view the video clip (of the negative event) remotely, from their individual laptop, desktop, I-phone, or PDA, to determine exactly what went on and who was at fault before making a decision about what to do about the incident. In this way, both the club's inventory and cash receipts are protected by constant monitoring.

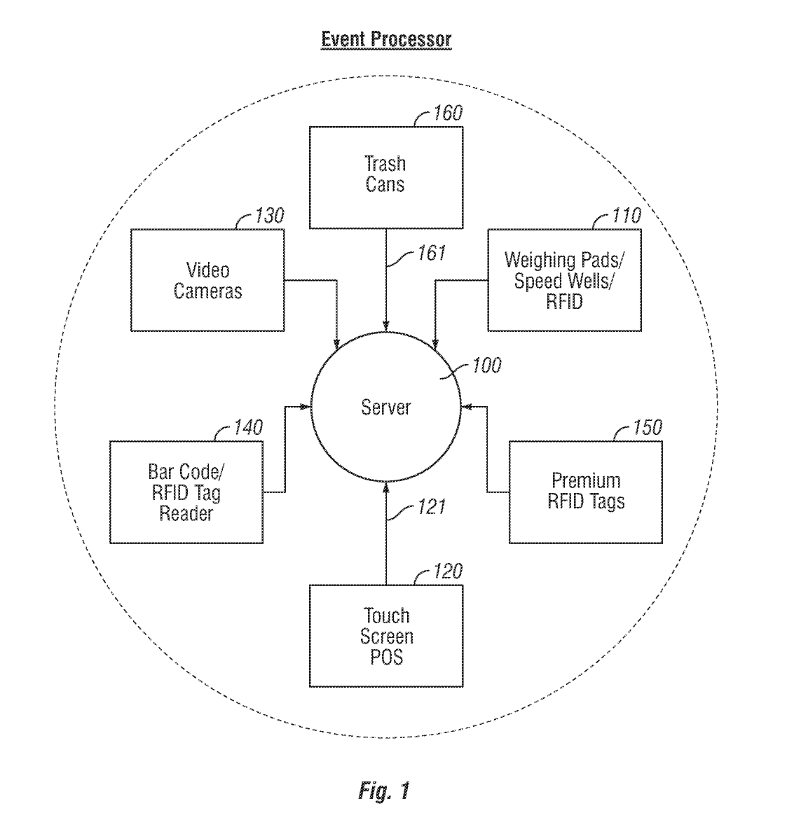

In an embodiment, the system referred to herein incorporated and comprises all of the following components which may also or alternatively include the hardware described in Ser. No. 11/862,347, filed Sep. 27, 2007, the entire contents of which are herewith incorporated by reference. However, the present system has some additional and modified features relative to the hardware discussed above. According to an embodiment, the block diagram of FIG. 1 may be used. The central server 100 includes software that runs according to the techniques described herein to form an event processor system. The server connects with a number of different external devices, each of which produces an electronic signal, either wired or wireless, that can be understood by the server 100. Server 100 may have a standard operating system, the software-driven event processor, and a functionality for communicating with the outside world either by Ethernet connection, wireless TCPIP connection or Wi-Fi connected to the Internet Cloud.

The hardware may include a rack of wireless weighing pads positioned beneath a series of liquor bottles (stored in a speed well rack 110); all of which have previously been tagged with an RFID (iCode for example) 13.56 mhz tag. Alternatively, the weighing pads can use any similar, proximity activated tagging device. A touch screen point of sale cash register 120 with cash drawer also produces an electronic signal output 121. There are a number of video cameras, shown generically as 130, with preferably each video camera located above each rack of bottles (that may include a multiplicity of bottles, racks, and cameras in each facility or customer's location or venue).

An inventory entry hand-held portable reading device 140 is used for reading bar-codes and RFID tags for the purpose of logging in the merchandise as it is received in the stockroom. The inventory device may also include an RFID tag reader device. In this embodiment, the “premium” shelves of liquor may use a higher security system. For example, the premium RFID tags shown as 150 may be of the UHF type as opposed to the 13.56 mhz i-code version, and there may be more of them and higher security video associated with them. In one embodiment, barcodes and video may be used for the low-end alcohol, while RFID and other such wireless tags may be used for the higher-quality bottles. In one embodiment, only weighing might be used for the lower end alcohol, while movement detection may be used on the higher end alcohol in addition to weighing, where either moving or a weight difference may trigger a possible event.

Another embodiment and/or piece of hardware includes the electronic trash cans which are trash cans for the bottles that receive the “dead” bottles that are deposited when they are empty. The trash cans include barcodes/RFID readers, that can read the information from the empty bottles, and produce an output 161 sent to the server indicating that the bottle is empty. In one embodiment, the trashcan has an inbuilt RFID tag reading device with antenna which reads various types of RFID tags and various frequency RFID tags at once.

The event processor operates as described herein, and can output stored data to a printing device, another server, a laptop, desktop, PDA, or iPhone at the owners request or preference at any time during the course of the business day or at any time the owner, manager, or authorized person so desires.

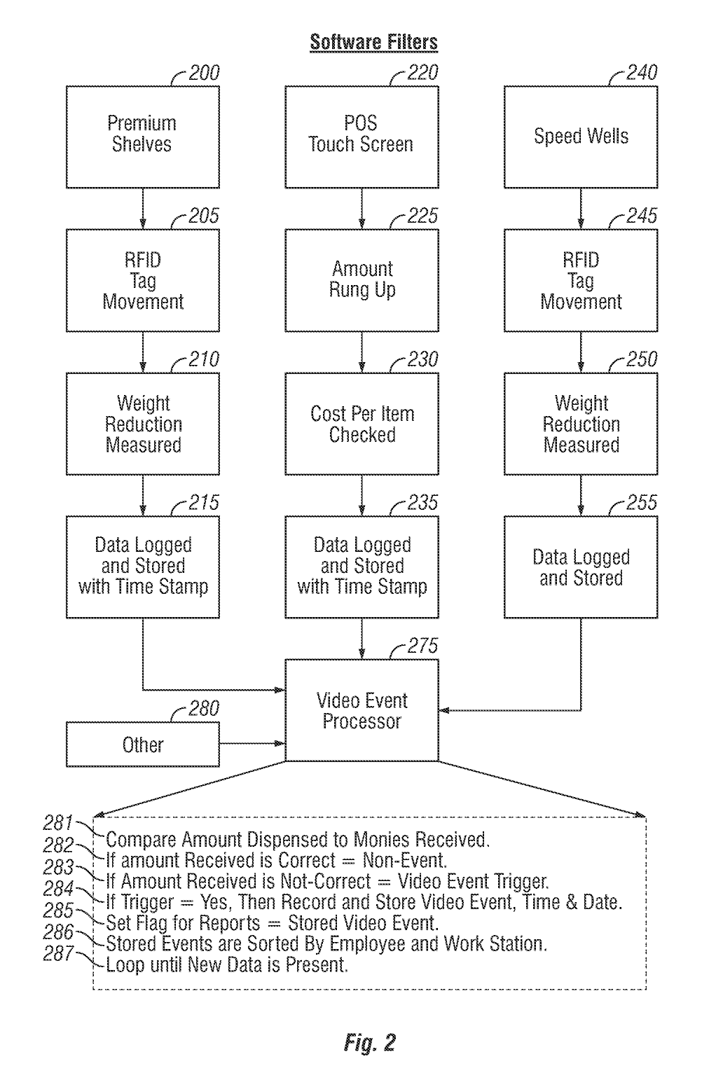

FIG. 2 illustrates the software filters that are carried out by the event processor. Three streams of operation simultaneously may occur and are monitored by the video event processor. The “premium shelves” at 200 may monitor RFID tag movement at 205, and also measure weight reduction of the bottle using the scale. That is, the RFID tag is detected to be moved, and the weight reduction is detected to have occurred. The data is logged and stored at 215 along with a time stamp.

In a parallel path of processing, the point-of-sale screen is monitored at 220. This detects the amount that was rung up at 225, detects the cost of the item at 230, and logs this at 235 with the timestamp. In the embodiment, the logging may occur in either a centralized processing unit or among multiple processing units which include a synchronized clock. In one embodiment, the inventory item that is detected to be moved or to be weight reduced can have an associated cost. That associated cost can be compared against the cost that was rung up,

At 240, the Speed wells are monitored. The Speed wells may be lower security devices that are used for the less premium shelves. At 245, RFID tag movement is detected. 250 represents detecting the weight reduction. 255 logs and stores the data with the timestamp.

All of the operations are logged and stored in the video event processor 275, which also receives other inputs shown generically as 280. The other inputs may include, for example, clips of video. The video event processor operates according to the flowchart shown in the bottom of FIG. 2.

At 281, the video event processor compares the amount dispensed to the monies received over a time period. For example, if RFID tag movement is detected at 245, and/or 250 detects a weight reduction, this all occurs at a time x and/or x+1. Some time either before or after the RFID tag movement at 245 or weight reduction at 250, the user should be paying for the dispensing action associated with the movement and/or weight reduction. For example, the user should either pay cash, or their “tab” is normally charged within 1 to 2 min. after the alcohol is dispensed. This 1 to 2 min period can be changed, but represents a time period in which some consumer should be charged for the dispensing of the alcoholic beverage. At 282 if the amount received is correct, then no event is established. At 283 if the amount received is not correct, then a video event trigger is carried out. At 284, if the trigger is positive, then the event is recorded and the video event is stored along with the time and date. The video information is shown received as 280. At 285, a flag is set for reports based on the video event. At 286 the stored events are sorted by an employee or owner at a workstation, and 287 loops until new data is present.

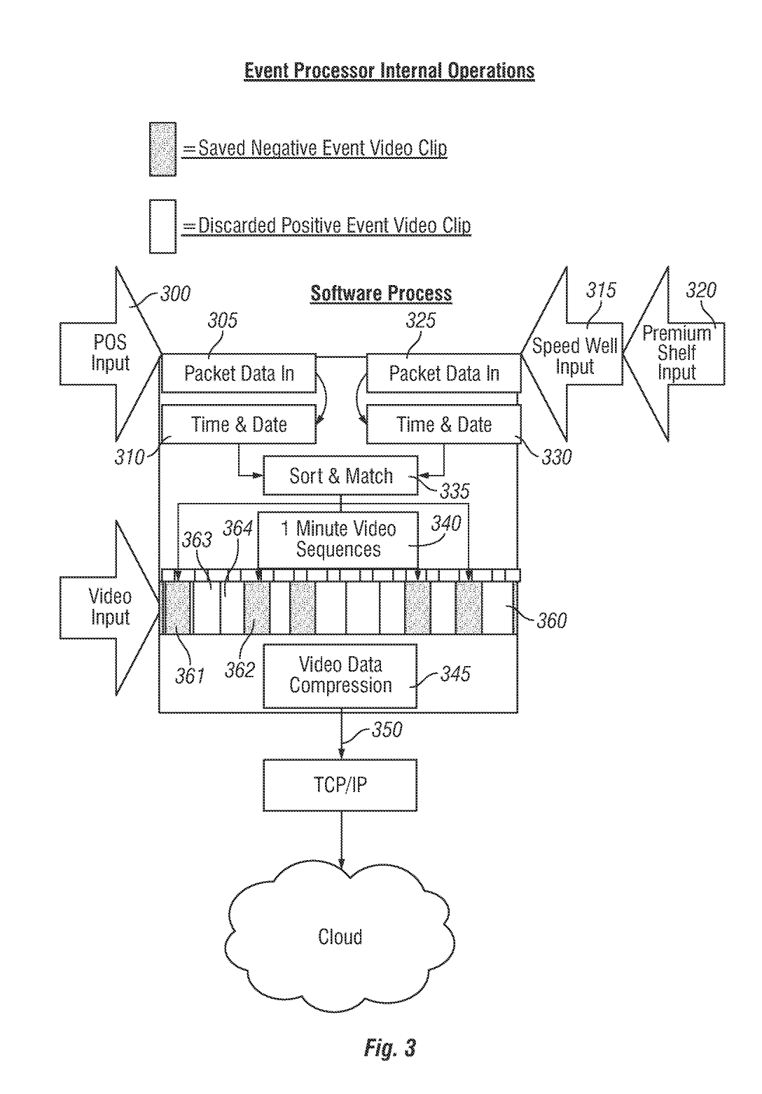

The event processor internal operations are shown in generic form in FIG. 3. The event processor is intended to be carried out in software, however is shown as hardware blocks. At one side of the event processor, the point-of-sale input is received, which is shown as packet data in 305 along with the time and date 310. The time and date may be received along with the packet data or if the packet data is received in real time then this may be optional. Simultaneously, both the Speed wells 315 and the premium shelf output 320 produce packet data in 325 along with times and dates 330. These are sorted and matched at 335. Based on the sorting and matching, criteria are established.

For example, any time that a premium shelf input is detected as being moved without a corresponding point-of-sale input, then an event may be established. The Speed well input may use a different criteria, for example the speed well may require that there is actually both the movement and the weight reduction before it looks for packet data.

In another embodiment, the monetary transaction for premium alcoholic beverages is compared against a database to determine if the monetary transaction is for a correct amount. However, the monetary transaction for non-premium alcoholic beverages is not compared against a database to determine if said monetary transaction is for a correct amount, but rather only checked to see if there is a matching transaction. This allows the bartender, for example, to provide discounts on well drinks, but not to provide corresponding discounts on premium drinks.

In the embodiment, the data are all associated with employee IDs, so what an employee who causes the movement of the alcoholic bottle, or causes a weight reduction, is correspondingly tested to see if they created a monetary transaction.

Whenever there is an event detected, the sort and match operation at 335 detects this. This also determines location and time, and 340 then sorts through the different stored video sequences to find 1 minute video sequences that can be associated with the event. The video data is compressed at 345, using compression techniques and also using techniques of reducing the resolution size to fit to for example a cellular phone or iPhone. This information is sent at 350 over the Internet to a destination, for example by e-mail or to an iPhone.

In the embodiment, the overall video 360 is sorted into different event video clips shown as darkened sections such as 361, 362 representing negative event video clips. 363 shown as the light colored clips and 364 are positive event video clips and are not sent and may be eventually discarded.

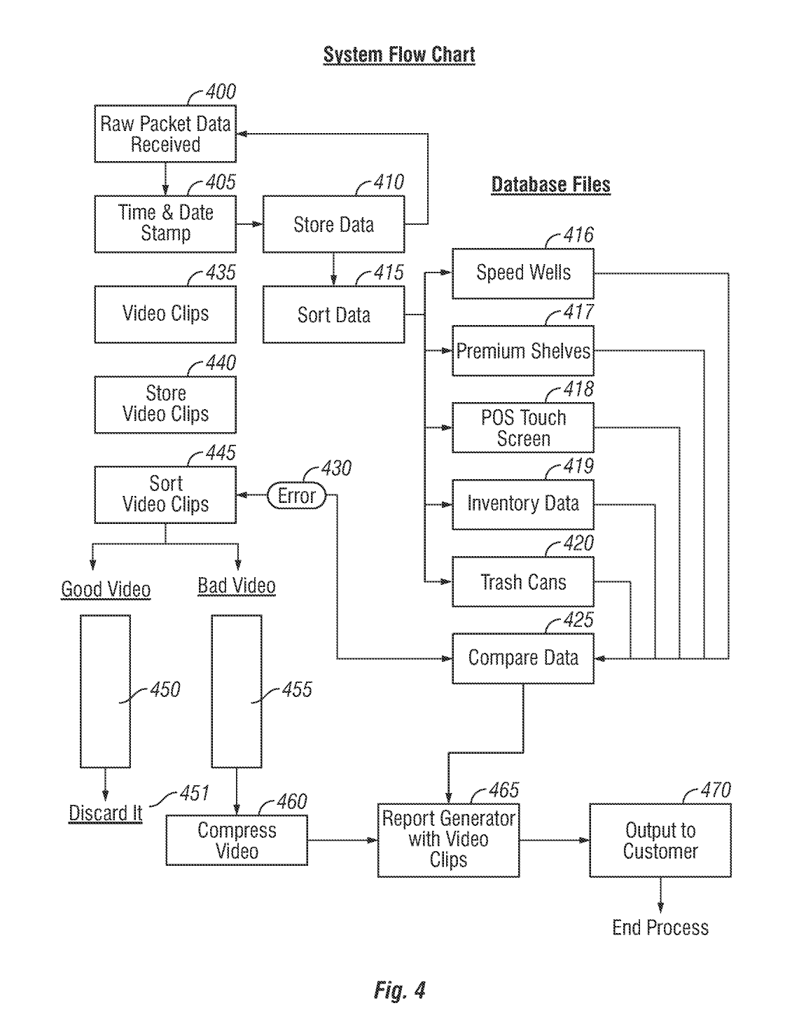

FIG. 4 shows a system flowchart of the operation. At 400, the raw packet data is received as shown in FIG. 3, along with the time and date stamp at 405. This data is stored at 410 and sorted at 415 to find different information about the data including the Speed wells 416, premium shelf products 417, point-of-sale events 418, inventory data 419, and trashcan data 420. All of this data is sorted and compared at 425 to find events which are communicated as 430.

The video clips are also received as 435 and stored as 440. The event data received at 430 is used to sort the video clips at 445 into non-event video 450 and event-including video 455. The event including video is video that is associated with a negative event. The non-event video is discarded at 451 or otherwise archived. The event including video is compressed at 460, and sent to the report generator at 465 along with video clips to be output to the customer at 470.

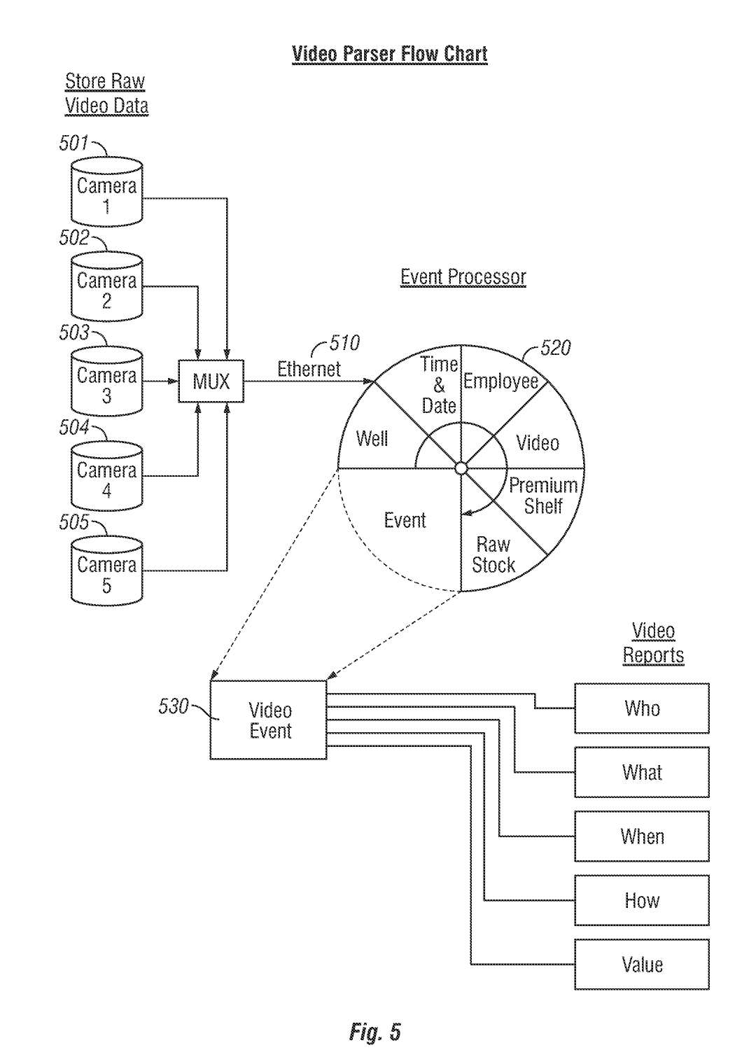

FIG. 5 illustrates the video parser system which obtains data from a number of cameras, and determines which of this data is used. For example, FIG. 5 shows that there are five cameras shown generically as 501-505. These cameras are multiplexed or otherwise connected to an ethernet connection 510 to the event processor shown in this embodiment as 520. The event processor as previously described combines all of the data including the speed wells, time and date, employee, video, premium shelf and raw stock to find an event.

If the event is established at 530, then the location of the event is also established based on the location from which the Speedwell or premium shelf event occurred. The camera 501-505, or cameras which are closest to this event are then identified. The data from these cameras are saved as the video event 530. This also creates the video reports, along with data from the event processor such as who, what, when, how and the value.

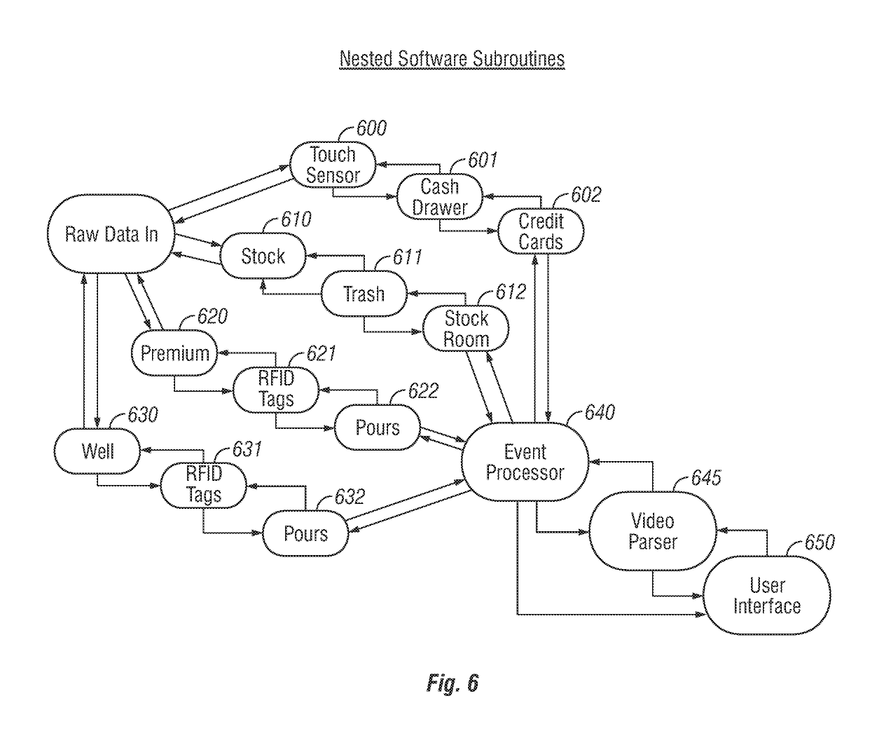

The raw data may be processed as shown in FIG. 6. As shown, this may receive information from the point-of-sale unit 600, inventory managing 610, premium information 620 and well information 630. The point-of-sale information 600 includes information from the cash drawer 601 and credit card transactions 602. The stock information includes information from the trashcan 611 and the stockroom 612, according to the inventory control operations for example carried out by element 140. The premium and well information are maintained separately, with premium information receiving RFID information at 621 and pours it 622 when the well information receiving RFID at 631 and pours at 632. All of this is combined by the event processor 640 combined with video clips at 645, under control of the user interface 650.

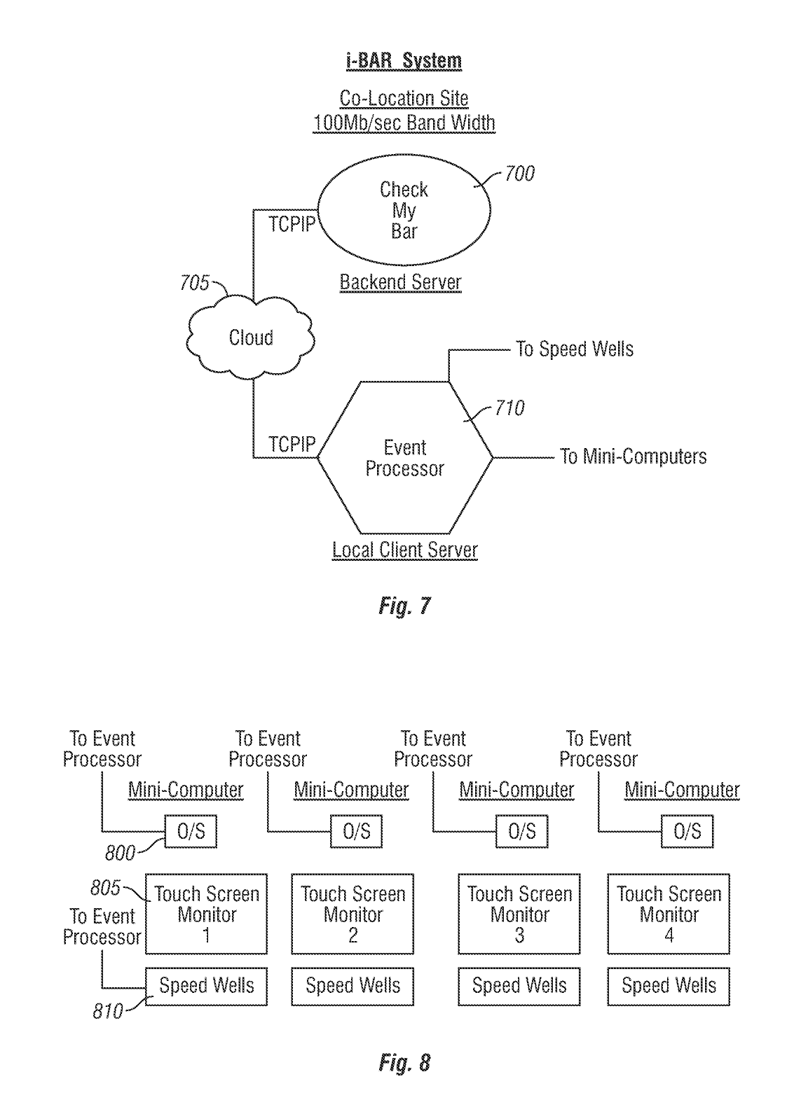

FIG. 7 shows the connection between the backend server and the event processor. The backend server 700 maintains information and carries out processing as described herein. This may be connected via the Internet 705 to an event processor 710. The event processor connects to the speed wells and to the multiple computers as shown in FIG. 8. FIG. 8 shows the multiple computers such as 800, connected to the event processor, which can include computers that are associated with events including the top shelf operation.

FIG. 8 also shows how the touchscreen point-of-sale devices 805 and the speed wells 810 are connected to the event processor.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example other hardware and software can be used. Moreover, while this describes use with metering of alcohol, this can also be used for other inventory control purposes such as prescription drugs.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system, comprising:
a computer that is programmed to receive information from a plurality of sources, including first information indicative of a movement of a first inventory item and second information indicative of whether payment for said first inventory item has been received, said computer determining whether payment for said first inventory item has been received during a first time period associated with when said first inventory item has been moved, and establishing a first event when said first inventory item has been detected to be moved without said payment for said first inventory item being received during said first time period, said computer also receiving video information, and storing a clip of said video information for a second time period that is associated with and includes said first time period, said clip of said video information associated with information about said first event.

2. A system as in claim 1, further comprising receiving third information indicative of a weight of said inventory item, and also using a change in said weight to determine said first event.

3. A system as in claim 1, wherein said inventory item includes alcoholic beverages.

4. A system as in claim 3, wherein said inventory item includes premium alcoholic beverages and nonpremium alcoholic beverages, and an event for said premium alcoholic beverage is detected using a different criteria than an event for said nonpremium alcoholic beverage.

5. A system as in claim 4, wherein said first event is established for said premium alcoholic beverage with only a movement of said alcoholic beverage without said payment during a time period, and said event for a nonpremium alcoholic beverage requires both said movement of said alcoholic beverage and also a weight reduction of alcoholic beverage, and also without said payment during said time period.

6. A system as in claim 1, further comprising receiving information from a trash receptacle, indicative of sensing empty containers which have been put into the trash receptacle.

7. A system as in claim 1, wherein said video information includes time information, and said information about said first event includes time information, and further associating said video information with said information about said first event.

8. A system as in claim 1, wherein said first inventory item has an associated cost for dispensing of the first inventory item, and said payment is compared against said cost to see if said payment is for a correct amount.

9. A system as in claim 5, wherein said first inventory item has an associated cost for dispensing of the first inventory item, and said payment is compared against said cost to see if said payment is for a correct amount for premium alcoholic beverages but said payment for non-premium alcoholic beverages is not compared against said cost to determine if said payment is for the correct amount.

10. A method, comprising:
receiving information into a computer from a plurality of sources, including first information indicative of a movement of a first inventory item and second information indicative of whether payment for said first inventory item has been received;
determining, in said computer, whether payment for said first inventory item has been received during a first time period associated with when said first inventory item has been moved, and establishing a first event when said first inventory item has been detected to be moved without said payment for said first inventory item being received during said first time period;
receiving video information, and storing a clip of said video information for a second time period that is associated with and includes said first time period, said clip of said video information associated with information about said first event.

11. A method as in claim 10, further comprising receiving third information indicative of a weight of said inventory item, and also using a change in said weight to determine said event.

12. A method as in claim 11, wherein said inventory item includes alcoholic beverages.

13. A method as in claim 12, wherein said inventory item includes premium alcoholic beverages and nonpremium alcoholic beverages, and an event for said premium alcoholic beverage is detected using a different criteria than an event for said nonpremium alcoholic beverage.

14. A method as in claim 13, wherein said first event is established for said premium alcoholic beverage with only a movement of said alcoholic beverage without a corresponding payment during a time period, and said event for a nonpremium alcoholic beverage requires both said movement of said alcoholic beverage and also a weight reduction of alcoholic beverage, and also without a corresponding payment during said time period.

15. A method as in claim 11, further comprising receiving information from a trash receptacle, indicative of sensing empty containers which have been put into the trash receptacle.

16. A method as in claim 11, wherein said video information includes time information, and said information about said first event information includes time information, and further associating said video information with said information about said first event.

17. A method as in claim 16, further comprising receiving a plurality of different items of video information from a plurality of different sources, and selecting those items of video information which best show information about said event.

18. A method as in claim 11, wherein said first inventory item has an associated cost for dispensing of the first inventory item, and said payment is compared against said cost to see if said payment is for a correct amount.

19. A method as in claim 14, wherein said first inventory item has an associated cost for dispensing of the first inventory item, and said payment is compared against said cost to see if said payment is for a correct amount for premium alcoholic beverages but said payment for non-premium alcoholic beverages is not compared against said cost to determine if said payment is for the correct amount.
